(19) United States
(12) Patent Application Publication
(10) Pub. No.: US 2009/0306620 A1
(43) Pub. Date: Dec. 10, 2009

(54) MEDICINAL VIAL

(76) Inventors: Jacques Thilly, Rixensart (BE); Christian Vandecasseric, Rixensart (BE)

Correspondence Address: KLARQUIST SPARKMAN, LLP, 121 SW SALMON STREET, SUITE 1600, PORTLAND, OR, 97204, US

(21) Appl. No.: 12/224,765

(22) PCT Filed: Mar. 5, 2007
(86) PCT No.: PCT/EP2007/052061

§ 371 Date: Mar. 11, 2009

(30) Foreign Application Priority Data
Mar. 7, 2006 (GB) 0604591.8

(51) Int. Cl. A61J 1/06; B23P 11/00

(52) U.S. Cl. 604/415; 29/428

(57) ABSTRACT

Medicinal vials are provided incorporating RFID's in a way which causes them to remain associated with the vial when the vial closure is opened. Several embodiments are disclosed. In a preferred embodiment an RFID is incorporated in the vial closure system.

This invention relates to medicinal vials, in particular to vials incorporating an RFID device.

Medicinal vials are well known, generally comprising a cylindrical vial body having a mouth opening closed by a closure having a penetrable region, usually made of an elastomer material, through which a hollow tubular needle may be driven to introduce liquid material into the vial, e.g. for filling the vial or reconstitution of content within the vial, and/or for extraction of liquid content from the vial. Such vials are usually cylindrical, and have their mouth opening at one longitudinal end, and a base at the opposite longitudinal end. In this description such terms as “upward” and related terms refer to the vial in its normal vertical orientation standing on its base. Such a medicinal vial may contain a medicinal substance such as a pharmaceutical drug substance or vaccine etc. A particular problem with such vials is that of correctly identifying the vial and its contents at various stages of its life, e.g. to ensure that the correct vial has been packed into its packaging, to ensure that the correct vial has been dispensed to a patient, and especially to protect against counterfeiting such as the unauthorized manufacture and supply of counterfeit vials superficially identical in appearance to the genuine product.

One proposed solution to these problems is to incorporate a Radio Frequency Identification Device (RFID) into the vial. RFID's have been incorporated into containers such as vials for various purposes. DE-202 14 099 U1 discloses a drinks bottle with an incorporated RF transponder. DE-A-10 2004 046 003 discloses a syringe with an RFID embedded in the plastics material of its body. DE-A-102 18 417 discloses a plastic container with a transponder chip located beneath its cap. CA 2 204 207 discloses a bottle with an electronic transmitter disposed in a cavity in its bottom. DE-C-44 39 914 discloses a bottle with an electronic transponder situated between its inner and outer shell walls. WO-A-2002/095675 and JP-A-2005 258350 disclose incorporation of an RFID into a label for attachment to a vial. GB-A-2 342 203 and WO-A-2003/001429.

In the technical field of pharmaceutical vials there are particular technical requirements. One requirement is that the RFID should remain associated with the vial for as long as possible to allow the vial to be tracked using its RFID for as long as possible. RFID Journal Apr. 29, 2005: Mary Catherine O'Connor; “Packager Uses Tags to Protect Injectables” (www.rfidjournal.com/article/articleview/1542/1/1) discloses a medicinal vial in which an RFID is incorporated in a flip off cover over the penetrable closure of the vial. In the vial disclosed in this article the RFID is stacked on top of the plastic cap of the vial. This arrangement has the disadvantage that the RFID necessarily becomes detached from the vial prior to insertion of the needle through the closure, leaving an opportunity for error in identification of the vial when the flip off cover incorporating the RFID has been removed.

A further requirement is the need to sterilize the vial. Gamma ray sterilisation is commonly used, but this can damage the delicate circuitry of an RFID.

An RFID normally comprises an electronic microchip and an antenna. The antenna normally comprises an elongated conductive member, which is commonly wound into a circle or a helical coil. Commonly the microchip and the antenna are attached to a thin plastics material substrate to provide a substantially flat device.

It is an objective of the present invention to address these problems by providing a medicinal vial incorporating an RFID which remains associated with the vial when its closure system has been opened, and the RFID is impossible or difficult to remove without leaving evidence of tampering.

According to a first aspect of this invention a medicinal vial is provided comprising a vial body having a mouth opening closed by a closure system attached to the vial, the closure system comprising:

an elastomer closure having a penetrable region through which a hollow tubular needle may be driven,

a cover able to engage with the vial and with the closure to thereby hold the closure in a closing relationship with the mouth opening of the vial, the cover covering the penetrable region,

the cover comprising a cover part which is openable to thereby expose the penetrable region for penetration by a needle,

the closure system incorporating an RFID, the incorporated RFID remaining attached to the vial upon opening of the openable part.

By the present invention, even when the cover part has been opened to expose the penetrable region for penetration by the needle the RFID remains mounted on the vial. Therefore the vial remains correctly identifiable by means of the RFID through and after the operation of inserting a needle through the closure to extract liquid content from the vial for administration of the content to a patient.

The vial body may be made of glass, but preferably the vial is made of a hard plastic material accepted for use in the pharmaceutical industry. A suitable type of polymer is a cycloelefin copolymer (“COC”), a blend thereof, or a blend thereof with another polymer. Examples of such COC polymers are for example disclosed in U.S. Pat. No. 5,723,189, EP-A-0436372 and EP-A-0556034 among others. A suitable hard plastic material accepted for use in the pharmaceutical industry is the cyclolefin copolymer “Topas” made by Celanese Corporation. For example the known COC polymers Topas 8007 or Topas 6015 may be used, available from for example Ticona GmbH (DE). Conditions for injection moulding this polymer to make vials therefrom are known in the art.

The closure may be a generally conventional elastomer plug sealingly engaging with the flange around the mouth opening of the vial, and penetrable by a needle.

The cover and the cover part are preferably made of a resilient plastics material. Such materials are preferred because they interfere less with the transmission of electromagnetic radiation to and from the RFID. Resilient plastics materials also facilitate a construction of the cover which can engage with the vial, e.g. with a rim around the mouth opening of the vial, e.g. by a snap fit engagement under such a rim. Such a snap fit engagement also facilitates the engagement of the cover with the closure by means of the resilient action of the snap fit enabling the cover to compress the closure between the rim of the mouth opening and the cover.

In an embodiment the cover part may be an openable, e.g. removable, part of the cover. For example the cover part may be connected to an adjacent part of the cover by means of a severable link, and the cover, cover part and such link may be made integrally e.g. of plastics materials by injection moulding.

For example the cover may have an aperture therein through which the penetrable region may be exposed for penetration by a needle, the aperture being closed by the cover part which is openable to thereby expose the penetrable region for penetration via the aperture.

In another embodiment the cover is a multi-part, e.g. two part construction, comprising a clamp part which is attached to the vial, and a cover part which is attached to the clamp part, the cover part incorporating the openable cover part. Such two parts may for example attach together by means of a snap fit engagement between the clamp and cover parts. For example the cover part may be connected to the cover part by means of a severable link, and the cover, cover part and such link may be made integrally e.g. of plastics materials by injection moulding.

For example the clamp part may have an aperture therein through which the penetrable region may be exposed for penetration by a needle, the aperture being closed by the cover part which is openable to thereby expose the penetrable region for penetration via the aperture.

An example of a vial with such a two part cover, comprising a clamp part and a cover, is that disclosed in WO-A-04/018317.

The RFID may be incorporated in the closure system in various ways.

For example the RFID may be embedded in the plastics material of the closure system, particularly in a part of the closure system which remains attached to the vial when the cover part has been opened.

For example a cavity to enclose the RFID may be provided in the closure system. In the embodiments discussed above such a cavity may be provided between the cover and the closure or between the clamp part and the closure.

For example in a closure system which comprises the above mentioned clamp and cover parts a cavity may be provided between the clamp and cover parts.

The cavity may be of any convenient shape suitable to enclose an RFID, but a generally toroidal cavity is found to be particularly convenient, for example in accommodating the antenna of the RFID. A toroidal cavity may for example be centered about the aperture in the cover.

Conveniently for the above embodiments the RFID may comprise an electronic microchip, and an antenna which is wound into a coil, the microchip and the antenna being attached to or embedded in a plastics material substrate, and the plastics material substrate incorporates a void through which a needle may be passed.

Such a substrate may be a ring-shaped substrate with a central void. Such a ring-shaped substrate is particularly suited to the above-mentioned toroidal cavity.

When the cover or clamp part includes the above-mentioned aperture via which the needle may penetrate the closure, the RFID of this embodiment may be mounted on the vial such that with the RFID mounted on the vial, the void and the aperture in the cover are coaxial, so that the linear longitudinal axis of a needle inserted through the aperture passes through the void.

The above-mentioned preferred construction in which the closure system comprises the clamp part and cover part, and the cavity is formed between the clamp part and cover part provides an advantage as follows. This construction facilitates an assembly procedure in which the RFID is connected to the cover part prior to attachment of the cover to the clamp part. The clamp part may be provided attached to the vial so that the combination of vial and clamp part may be sterilized by gamma radiation without risk of damaging the RFID with the gamma radiation. The combination of cover and RFID may be independently sterilized by a process that does not risk damage to the RFID, e.g. exposure to ethylene oxide or another chemical sterilizing agent. The sterilized combination of cover part plus RFID may then be attached to the clamp part. The RFID may be connected to the cover part by any convenient method, e.g. a friction fit, gripping lugs on the cover, adhesive etc.

These sterilization procedures are particularly useful for vials of the type disclosed in WO-A-04/018317. In that vial there is a ring-shaped knife-edged sealing ridge on the underside of the cover part. This ridge engages with the upper surface of the elastomer closure to enclose a volume sealed by the ridge. If the cover part is sterile, and the upper surface of the elastomer closure is sterile, and the cover part is attached to the clamp part under sterile conditions, then the enclosed area of the upper surface of the closure remains sterile. Consequently when the cover part is removed to expose this area a needle can be inserted through this area without fear of contamination. The sterilization procedures described above facilitate this. Methods of maintaining sterile conditions, e.g. a laminar flow of sterilized air are well understood in the art.

Consequently the invention further provides a process for assembling a combination of a vial and a closure system in which:

a vial having its mouth opening closed by an elastomer closure having a penetrable region through which a hollow tubular needle may be driven, and having a clamp part engaged with the vial and with the closure to thereby hold the closure in a closing relationship with the mouth opening of the vial, is provided in a sterilized state,

a cover part is provided which may be engaged with the clamp part, the cover comprising a cover part which when the cover is engaged with the clamp part is openable to thereby expose the penetrable region for penetration by a needle, the cover incorporating an RFID, is provided in a sterilized state,

then the cover part, with its incorporated RFID, is attached to the clamp part.

Suitable and preferred constructions of such a vial, clamp part and cover are as described above.

This process may form part of an overall process in which prior to the attachment of the cover to the clamp part a liquid material is introduced into the vial via a hollow tubular needle driven through the closure, and the needle subsequently withdrawn. Preferably the residual puncture hole left by the needle is then heat sealed.

The use of injection mouldable plastics materials such as the above-mentioned cycloelefin copolymers (“COC”), a blend thereof or a blend thereof with another polymer facilitates a further method of incorporating an RFID into a vial body to provide a medicinal vial incorporating an RFID which remains associated with the vial when its closure system has been opened, and the RFID is impossible or difficult to remove without leaving evidence of tampering.

Therefore according to this invention there is provided a medicinal vial comprising a vial body having a mouth opening closed or closeable by a closure system attached to the vial body, the vial body being made of an injection mouldable plastics material, with an RFID embedded in the plastics material of the vial body.

Suitable injection mouldable plastics materials are the above-mentioned cycloelefin copolymers (“COC”), a blend thereof or a blend thereof with another polymer. The RFID may be embedded in the vial body by insert moulding. Modern RFID's are robust enough to withstand the temperatures, pressures and forces likely to be encountered in injection moulding of such a plastics material. This method of incorporating an RFID into the vial body makes it particularly difficult to remove the RFID or physically tamper with it without leaving evidence of physical disturbance of the vial body.

In a third way of providing a medicinal vial incorporating an RFID which remains associated with the vial when its closure system has been opened, and the RFID is impossible or difficult to remove without leaving evidence of tampering, there is provided a medicinal vial comprising a vial body having a mouth opening closed by an openable closure system attached to the vial body, the vial having a base opposite its mouth opening, the vial comprising a cavity adjacent to its base which cavity encloses an RFID.

The mouth opening of such a vial is closed by a closure system. The benefit of associating the RFID with the vial adjacent to its base is that on opening the closure system the RFID remains associated with the vial.

Such a cavity may comprise a concave region of the vial body e.g., at the base of the vial. When the vial body is made by injection moulding of a plastics material, e.g. those discussed above, such a cavity may easily be moulded. For example such a cavity may be defined by a skirt wall extending outwardly from the base of the vial body. Within such a cavity the RFID may be secured to the vial by for example adhesive, or by some kind of locking means engaging with the vial body.

In a fourth way of providing a medicinal vial incorporating an RFID which remains associated with the vial when its closure system has been opened, and the RFID is impossible or difficult to remove without leaving evidence of tampering, there is provided a medicinal vial comprising a vial body having a mouth opening closed or closeable by a closure system attached to the vial body, the vial body is formed with an attachment part, and a holder defining a cavity enclosing an RFID and having a corresponding attachment part is attached to the vial body by engagement of the respective attachment parts.

Such attachment may be such that removal of the holder from the vial, or opening of the housing to disturb the RFID, would be difficult without leaving evidence of physical tampering.

Suitably the attachment part of the vial body is adjacent to the base of the vial body, i.e. conveniently dissociated from the closure system.

For example the attachment part of the vial may comprise an external downwards extension from the base of the vial, e.g. a cylindrical skirt, incorporating a connection part, e.g. a snap-fit connection.

For example the holder may comprise a ring-shaped holder having a central aperture with a corresponding connection part, whereby the skirt and ring-shaped holder may engage together. Such a holder may conveniently incorporate a ring-shaped cavity suitable for enclosing therein a ring-shaped RFID as described above with reference to the first aspect of this invention.

The RFID may be otherwise conventional. For example the RFID may have an operating frequency in the high frequency range, e.g. typically 13-14 MHz. The RFID may be encoded with data for example, relating to the identity of the contents of the vial, the production batch number of the contents of the vial, the expiry date of the contents of the vial, or other coded information relating to the contents of the vial. The RFID may be a write-once, read-many times RFID, a read-only RFID, or may be an RFID into which information may be written. Of particular value in anti-counterfeiting applications the RFID may be a secured read/write RFID. By means of the RFID incorporated into the vial, the vial, its contents etc. can be identified precisely at all necessary steps of processing of the vial, for example filling/capping/inspection for particles/labelling/packaging. This allows the manufacturer to identify the product (including the product filled in the vial before there is any label on it) and to make sure there is no mix up at any of the consecutive steps. Later in the supply chain it is a way to check the identity of the product, check for mix up and to easily control a situation of product recall. By use of the secure read/write RFID counterfeiting of vials may be hindered.

Such an RFID may be written to or read from by known types of writer-reader systems, typically over a range of ca. 30 cm.

In certain embodiments of the invention it is preferred to use a gamma ray-resistant RFID. For example when the RFID is situated between the clamp part and the closure, or is embedded in the material of the vial body, or is enclosed in a cavity adjacent the base of the vial body or is enclosed in a holder attached to the vial, the use of a gamma ray-resistant RFID allows the vial with its incorporated RFID to be gamma ray sterilized with a reduced risk of damage to the RFID. This enables the RFID to be coded as from its entrance into the filing process, enabling tracking of the vial right through the filling process.

The present invention will now be described by way of example only with reference to the accompanying drawings.

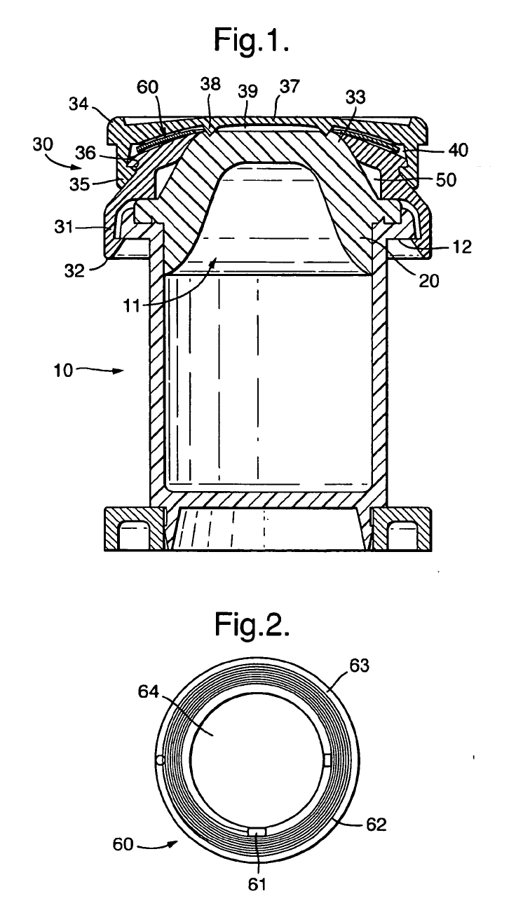

FIG. 1 shows a longitudinal sectional view of a vial plus RFID of this invention.

FIG. 2 shows a plan view of an RFID device as used in the vial of FIG. 1.

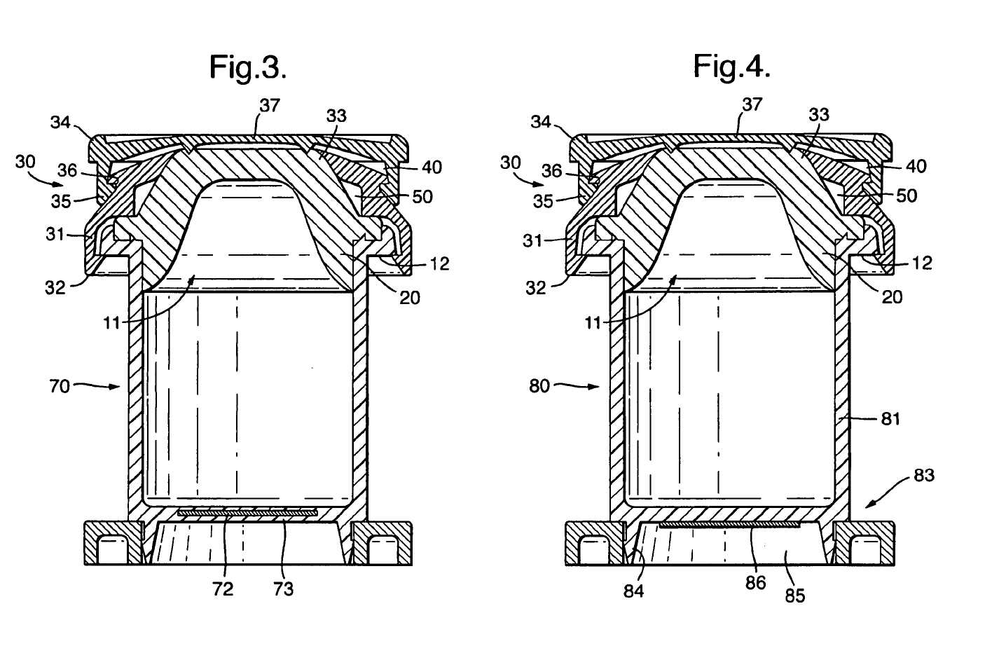

FIG. 3 shows a longitudinal sectional view of a vial with an RFID embedded in the material of the vial body.

FIG. 4 shows a longitudinal sectional view of a vial with an RFID enclosed in a cavity adjacent the base of the vial body.

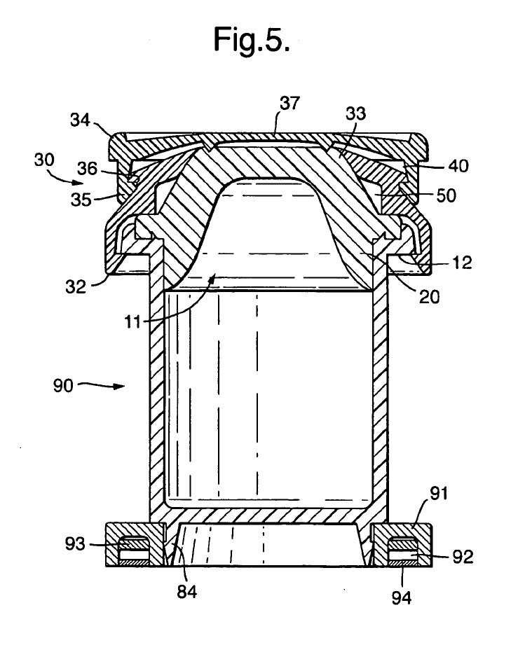

FIG. 5 shows a longitudinal sectional view of a vial with an RFID enclosed in a holder attached to the vial.

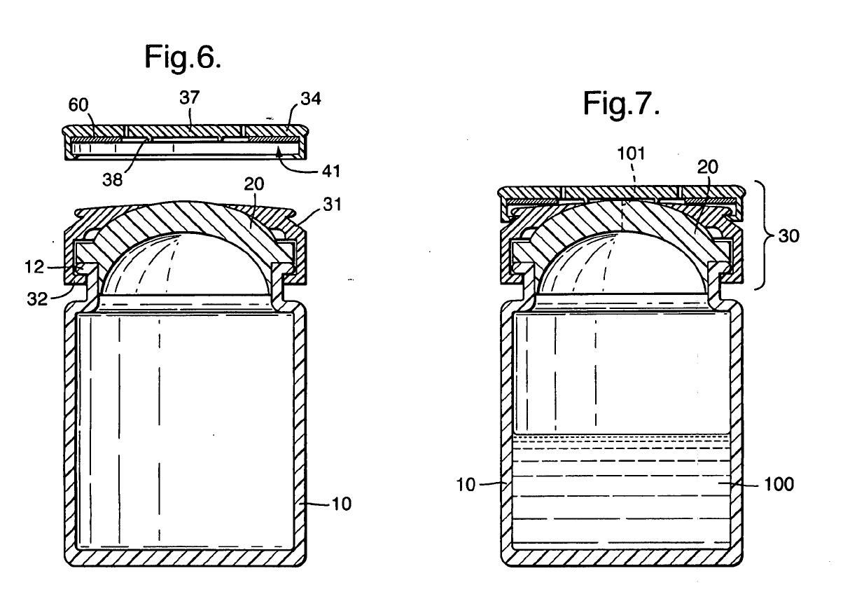

FIGS. 6 and 7 show a process for assembly of the vial of FIG. 1.

Referring to FIG. 1 Referring to FIG. 1 a vial 10 is shown being of generally cylindrical shape. It will be appreciated that the vial shown is that of WO-A-2004/018317. At its upper end as shown the vial 10 has a mouth opening 11. Vial 10 is shown in its conventional orientation with its mouth uppermost and its base downwards. The mouth opening 11 is surrounded by an outwardly extending rim 12 in the form of a flange.

Inserted into mouth opening 11 is a closure part 20 made of a thermoplastic elastomer material which is easily penetrable by a hollow needle (not shown).

A cover 30 generally holds the closure part 20 in place against the flange 13. The cover 30 is a two part construction, both parts being made of resilient plastics material. The cover 30 comprises a clamp part 31 which is attached to the vial 10 by means of a snap-fit engagement between the lip 32 of part 31 and the rim 12. The part 31 has a central circular aperture 33 therein through which a penetrable region 21 of the closure 21 may be exposed for penetration by a needle (not shown). The cover 30 also comprises a cover part 34 which is attached to the clamp part 31 by means of snap-fit engagement between the lip 35 of cover part 34 and an annular groove 36 in clamp part 31.

When in place as seen in FIG. 1 on the clamp part 31, the aperture 33 is closed by a central removable part 37 of cover part 34. The removable part 37 is connected to the cover part 34 by means of a severable link (not shown) e.g. small fragile integral plastic material links between the cover part 34 and removable part 37. The removable part 37 may thereby be removed from cover part 34 by severing the fragile links to thereby expose the closure 20 for penetration by a needle via the aperture 33.

A particular feature of the vial shown in FIG. 1 is the ring-shaped knife-edged sealing ridge 38 on the underside of the removable part 37 of cover part 34. This ridge 38 engages with the upper surface of the elastomer closure 20 to enclose a volume 39 sealed by the ridge 38. If the cover 34 is sterile, and the upper surface of the elastomer closure 20 is sterile, then the enclosed area of the upper surface of the closure 20 remains sterile. Consequently when the removable part 37 is removed to expose this area a needle can be inserted through this area without fear of contamination.

A toroidal (ring-shaped) cavity 40 is formed in the cover 30 between the clamp part 31 and cover part 34. This cavity 40 is coaxial with the aperture 33 and is concentric with aperture 33.

Another toroidal (ring-shaped) cavity 50 is formed in the cover 30 between the clamp part 31 and the closure 20. This cavity 50 is also coaxial with the aperture 33 and is concentric with aperture 33.

Located within cavity 40 is an RFID 60. FIG. 2 shows a plan view of the RFID 60. The RFID 60 comprises an electronic microchip 61, and an antenna 62 which is wound into a coil, the microchip 61 and the antenna 62 being attached to a ring-shaped substrate 63 with a central void 64. FIG. 1 shows how the RFID 60 fits in cavity 40 coaxially with the aperture 33. In a suitable construction the substrate 63 has a thickness of 75 microns, though could be made thinner, has an outer diameter of 18.7 mm, and the void 64 has a diameter of 10.5 mm. The antenna 62 comprises a double copper spiral having 7.5 coils in the upper spiral and 6.3 in the lower spiral. The coils of the antenna 62 are deposited by a printing technique, have a width of 18 microns and a spacing between coils of 200 microns.

Referring to FIG. 3 a vial 70 is shown in a longitudinal sectional view. It will be seen that the construction of vial 70 is that of FIG. 1 and the same numbering system is used. The vial body 71 is made of an injection mouldable plastics material such as the COC polymers mentioned above. An RFID 72 in the form of a flat device has been embedded by insert moulding in the plastics material of the vial body 71. The RFID 72 has been embedded in the material of the base wall 73 of vial 70. The RFID 72 is preferably a gamma ray-resistant RFID.

Referring to FIG. 4 a medicinal vial 80 comprising a vial body 81 having a mouth opening 11 closed by a closure system attached to the vial body is shown. It will be seen that the construction of vial 80 is that of FIG. 1, and the same numbering system as FIG. 1 is used. The vial body 81 is made of an injection mouldable plastics material such as the COC polymers mentioned above. The vial 80 has a base 83 (generally) opposite its mouth opening 81, and the base 83 of the vial 80 is in the form of a downwardly extending skirt 84 which defines an internal cavity 85. The cavity 85 encloses an RFID 86. The RFID 86 is in the form of a disc fitting neatly into the cylindrical cavity 85. The RFID 86 is retained in the cavity 85 by means of an adhesive connection between the RFID 86 and the under surface of the base 83, although other retention means could be used. For example a ring shaped stand 87 is attached to the base 83 of the vial 80 by means of a snap-fit connection between corresponding snap-fit connection parts on the outer surface of the skirt 84 and the inner surface of stand 87, and the stand 87 may be integrally extended radially inwardly to form restraints to hold the RFID 86 in place in cavity 85. In another construction a retaining ring (not shown) may be retained in the cavity 85, for example by a snap-fit engagement between the inner surface of the skirt 84 and the ring (not shown). The RFID 86 is preferably a gamma ray-resistant RFID.

Referring to FIG. 5, a vial 90 of similar construction to that 80 of FIG. 4 is provided. The outer surface of the skirt 84 is profiled to engage in a snap fit manner with corresponding snap fit parts on the ring-shaped stand 91, and the skirt 84 with its snap-fit parts consequently comprises an attachment part. The stand 91 incorporates a ring-shaped cavity 92, into which an RFID 93 is fitted, for example the ring-shaped RFID of FIG. 2. The cavity 92 may be closed by a suitable closure 94. The RFID 93 is preferably a gamma ray-resistant RFID.

Referring to FIGS. 6 and 7, the assembly of a vial as seen in FIG. 1 is shown schematically. In FIG. 6 parts corresponding to FIG. 1 are numbered correspondingly.

The clamp part 31 of closure system 30 is attached to the vial 10 by means of a snap-fit engagement between the lip 32 of clamp part 31 and the rim 12. The combination of vial 10 and clamp part 31 may be sterilized by gamma radiation.

The RFID 60 is inserted into the cavity the cover 34, fitting within a cavity 41 within cover part 34, and retained therein by a conventional means (not shown) e.g. gripping lugs, adhesive, a tight friction fit etc. The assembly of RFID and cover 34 may be independently sterilized by a process which does not adversely affect the RFID, e.g. by exposure to ethylene oxide.

Then as seen in FIG. 7 the assembly of cover part 34 and RFID 60 may be snap fitted to the clamp part 31 by a snap fit connection to produce an assembly as shown in FIG. 1. Prior to attachment of the cover 34 to clamp part 31 a liquid medicament 100 has been introduced into vial 10 via a hollow filling needle (not shown) driven through closure 20. Subsequent withdrawal of the filling needle has left a residual puncture hole 101, which may be sealed, e.g. by laser heat sealing, prior to attachment of cover 34.

After sterilization of the combination of vial 10 and clamp part 31, and of the assembly of cover 34 and RFID 60, this combination 10,31 and assembly 34,60 should be maintained in sterile conditions until they are snap fitted together as seen in FIG. 7.

1. A medicinal vial comprising a vial body having a mouth opening closed by a closure system attached to the vial, the closure system comprising:
a elastomer closure having a penetrable region through which a hollow tubular needle may be driven,
a cover able to engage with the vial and with the closure to thereby hold the closure in a closing relationship with the mouth opening of the vial, the cover covering the penetrable region,
the cover comprising a cover part which is openable to thereby expose the penetrable region for penetration by a needle,
the closure system incorporating an RFID, the incorporated RFID remaining attached to the vial upon opening of the openable part.

2. The medicinal vial of claim 1 wherein the cover and the cover part are made of a resilient plastics material.

3. The medicinal vial of claim 1 wherein the cover part is an openable part of the cover.

4. The medicinal vial of claim 1 wherein the cover has an aperture therein through which the penetrable region may be exposed for penetration by a needle, the aperture being closed by the cover part which is openable to thereby expose the penetrable region for penetration via the aperture.

5. The medicinal vial of claim 1 further comprising a cavity between the cover and the closure to enclose an RFID.

6. The medicinal vial of claim 3, wherein the cover comprises a clamp part which is attached to the vial and attached to the cover part.

7. The medicinal vial of claim 6 further comprising a cavity between the clamp part and cover part to enclose an RFID.

8. The medicinal vial of claim 5 wherein the cavity is toroidal.

9. A process for assembling the medicinal vial of claim 1 comprising:
providing the vial in a sterilized state wherein the mouth opening of the vial is closed by the elastomer closure, and wherein the vial comprises a clamp part which is engaged with the vial and with the closure to thereby hold the closure in a closing relationship with the mouth opening of the vial,
providing the cover in a sterilized state which may be engaged with the clamp part, the cover comprising a cover part which, when the cover is engaged with the clamp parts is openable to thereby expose the penetrable region for penetration by a needle, the cover incorporating an RFID, and,
attaching the cover part, with its incorporated RFID, to the clamp part.

10. The process of claim 9 wherein, prior to the attachment of the cover to the clamp part, a liquid material is introduced into the vial via a hollow tubular needle driven through the closure, and the needle is subsequently withdrawn.

11. The process of claim 10 wherein a residual puncture hole left by the needle is subsequently heat sealed.

12. A medicinal vial comprising a vial body having a mouth opening closed or closeable by a closure system attached to the vial body, the vial body being made of an injection mouldable plastics material, with an RFID embedded in the plastics material of the vial body.

13. A medicinal vial comprising a vial body having a mouth opening closed by an openable closure system attached to the vial body, the vial having a base opposite its mouth opening, the vial comprising a cavity adjacent to its base which cavity encloses an RFID.

14. A medicinal vial comprising a vial body having a mouth opening closed or closeable by a closure system attached to the vial body, the vial body being formed with an attachment part, and a holder defining a cavity enclosing an RFID and having a corresponding attachment part is attached to the vial body by engagement of the respective attachment parts.

15. The medicinal vial of claim 14 wherein the attachment part of the vial body is adjacent to the base of the vial body.

16. The medicinal vial of claim 14 wherein the holder is a ring-shaped holder incorporating a ring-shaped cavity.

17. The medicinal vial of claim 5 wherein the RFID is a gamma ray-resistant RFID.

18. The medicinal vial of claim 17 wherein the RFID is a secured read/write RFID.
